(19) United States
(12) Patent Application Publication
(10) Pub. No.: US 2008/0200355 A1
(43) Pub. Date: Aug. 21, 2008

(54) Aqueous Solution for Managing Microbes in Oil and Gas Production and Method for their Production

(76) Inventor: Stuart A. Emmons, Surfside Beach, SC (US)

Correspondence Address: MCHALE & SLAVIN, P.A., 2855 PGA BLVD, PALM BEACH GARDENS, FL, 33410, US

(21) Appl. No.: 12/013,510

(22) Filed: Jan. 14, 2008

Related U.S. Application Data
(60) Provisional application No. 60/884,726, filed on Jan. 12, 2007.

(51) Int. Cl. C09K 8/84

(52) U.S. Cl. 507/269; 700/271

(57) ABSTRACT

This invention relates to compositions for the management and treatment of water used for the production of oil and gas products comprising an electro-chemically activated, cation or anion-containing aqueous solution (catholyte or anolyte), and to a system and process for their production. A plant is described for treating water used for petroleum production and products including a water reservoir (15), a salt feed device (19) for creating an aqueous salt solution, an electrolysis device (21) to produce anolyte and catholyte solutions, an anolyte tank (31), a cation tank (32) and an anion holding/transport container (33) from which solution is injected into a petroleum processing, petroleum production enhancement or petroleum product application.

### REFERENCE TO RELATED APPLICATIONS

This application claims benefit of the filing date of Provisional Application 60/884,726, filed on Jan. 12, 2007, the contents of which are herein incorporated by reference.

### FIELD OF THE INVENTION

This invention relates to a composition for treating water to manage microbes, to a method of treating water to manage microbes, to a treatment plant and to a water product treated with such a composition.

### BACKGROUND OF THE INVENTION

For the purposes of this specification, the term “composition used to manage microbes” should be construed to include within its meaning the electrochemically activated bactericidal aqueous solution, water or water product obtained from the treatment of water with electrochemically activated bactericidal aqueous solution or the products containing electrochemically activated bactericidal aqueous solution. The invention is applicable particularly, but not exclusively, to the treatment of surface water, well water, stored water, processing water, cooling water, produced water, water used for the production of oil and gas products and water used to produce products that enhance the production of oil and gas products. The Applicant further envisages that a benefit of the water treatment will be the management of the bio-film that is associated with microbes found in untreated water.

### DESCRIPTION OF THE PRIOR ART

Illustrative of the prior art associated with this technology are U.S. Pat. Nos. 6,610,249, 6,004,439, 5,985,110, 5,871,623, 5,783,052, 5,635,040, 5,628,888, 5,540,819, 5,427,667, 6,267,855, and published applications WO03042111A2, US24131695A1, and US25029093A1.

### SUMMARY OF THE INVENTION

In accordance with a first aspect of the invention there is provided a method of managing microbes in the water used in oil and gas production applications, the method including the step of exposing the microbes in the water to a composition comprising an electro-chemically activated, anion-containing aqueous solution. The solution may be an aqueous solution of a salt. The salt may be sodium chloride. In particular, it may be non-iodated sodium chloride or potassium chloride. The method may include the steps of diluting the anion-containing solution to a pre-determined concentration and exposing the water to be treated to an appropriate quantity of the diluted anion-containing solution and for a predetermined time period in a treatment facility. If desired, the method may include collecting water in a treating vessel, disinfecting the water by treating it with an appropriate quantity of the diluted anion-containing solution and returning the treated water into the same or different geologic formation from which it came.

If desired, the method may include treating the water by exposing it to an appropriate quantity of the cation-containing solution, conditioning the water, and may include reducing the treated water surface tension.

The anion-containing solution and the cation-containing solution may be produced by an electrochemical reactor or so-called electrolysis device. The electro chemical reactor may include a flow-through, electro chemical cell having two co-axial cylindrical electrodes with a coaxial diaphragm between them so as to separate an annular inter electrode space into a catalytic and an analytic chamber. The anion-containing solution is referred to hereinafter for brevity as the “anolyte solution” and the cation-containing solution is referred to hereinafter for brevity as the “catholyte solution”. During the electrolysis process, various radical cation and radical anion species are produced. Generally, a saturated aqueous NaCl solution of water is added to tap water where it is electrolyzed in the anion and cation chambers to produce radical anion and radical cation species having extremely high redox potentials of between +500 and +1170 mV and between −600 and −980 mV respectively. These species may be labile after about 96 hours, with no residues, giving the appearance of never being produced. The anolyte solution generally may have a pH of about 2.0-8.5 and a redox potential of about +1170 mV. The species present in the anolyte solution may include ClO; ClO⁻; HClO; OH; HO₂—; H₂O₂; O₃; S₂O₈²⁻ and Cl₂O₆²⁻. These species have been found to have a synergistic anti-bacterial effect which is generally stronger than that of chemical bactericides and has been found to be particularly effective against gram positive vegetative bacteria, gram negative vegetative bacteria, mycobacteria, fungi, viruses, spores and phages. The catholyte solution generally may have a pH of about 10.5-13.0. The species present in the catholyte solution may include NaOH; KOH; CA(OH)₂; Mg(OH)₂; HO⁻; H₃O₂⁻; HO₂⁻; H₂O₂⁻; O₂⁻; OH⁻; O₂²⁻.

Exposing the microbes in the water to be treated to the anolyte solution may include applying the anolyte solution via undiluted dosing into vessels containing the water to be treated, or into water streams “on-the-fly” to manage microbes that could be disruptive to the performance of chemicals, gels and stimulation fluids used in the production of oil and gas. Further, microbes in the water to be treated may be exposed to anolyte solution via a slug dosing to accomplish a “shock” treatment down-hole in producing oil and gas wells.

In accordance with a second aspect of the invention, there is provided a treatment plant for treating water in accordance with the method of the invention. The treatment plant may include supply means for supplying water; feed means for feeding a suitable salt into the water to produce an aqueous salt solution; an electrolysis device for electrolyzing the aqueous solution to produce an anolyte and a catholyte solution; a mixing and dilution tank for mixing and diluting the anolyte solution; and means for applying the anolyte solution into water, or a product, for treatment. The treatment plant may include means for applying anolyte and catholyte solution into process water to manage microbes in the process water. In accordance with a third aspect of the invention there is provided a composition for treating water for microbes comprising an electro chemically activated anion containing aqueous solution, the solution being substantially as herein defined. In accordance with a fourth aspect of the invention there is provided a water treated for microbes characterized in having been treated for microbes with a composition and/or in a plant or a process as herein defined.

Accordingly, it is a primary objective of the instant invention to provide a novel composition for treating water used in oil and gas applications for microbes, as well as the related treated water and method.

It is a further objective of the instant invention to provide a method and device for producing a biocidal composition at tightly controlled parameters by virtue of a constant current controlled production system.

It is an additional objective of the instant invention to teach a novel electro-chemical conversion process utilizing a combination of programming parameters which interact with both electrical sequence and control systems and a unique hydraulic flow control pathway to yield a microbicidal solution capable of being maintained within tightly controlled parameters.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

Embodiments of the present invention are described by way of example with reference to the accompanying drawings wherein:

FIG. 1 is a schematic drawing of a treatment plant, showing one embodiment of the present invention.

FIG. 2 is a table providing the results of tests studying the bactericidal effects of the present anolyte solution.

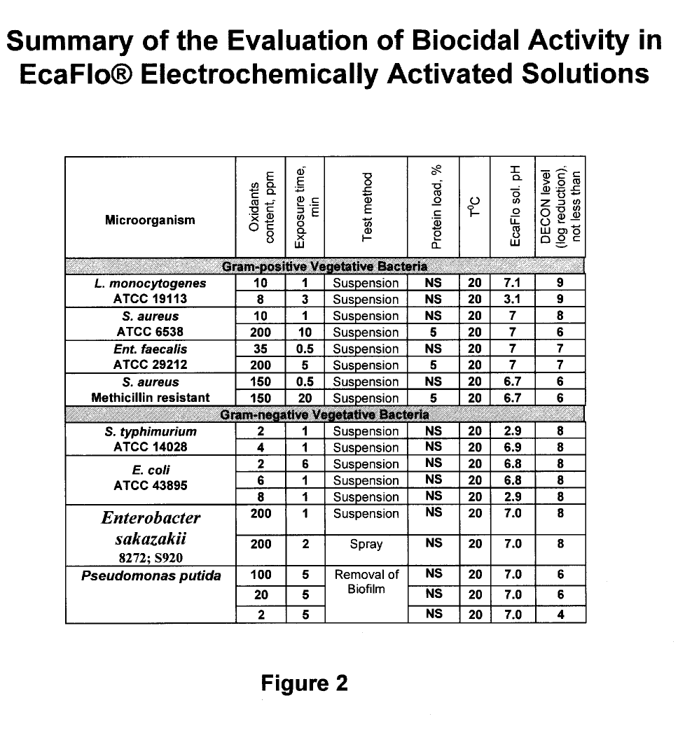

FIG. 3 is a table providing the results of tests studying the bactericidal and efficacy effects of the present anolyte solution on pond water.

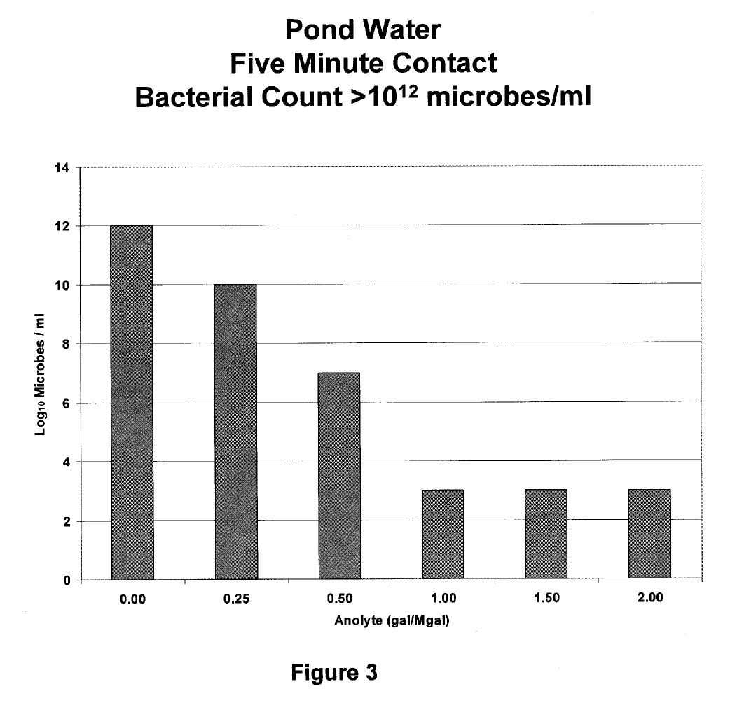

FIG. 4 is a table providing the results of further tests studying the bactericidal effects of the present anolyte solution in the preparation of water used in fracturing gels.

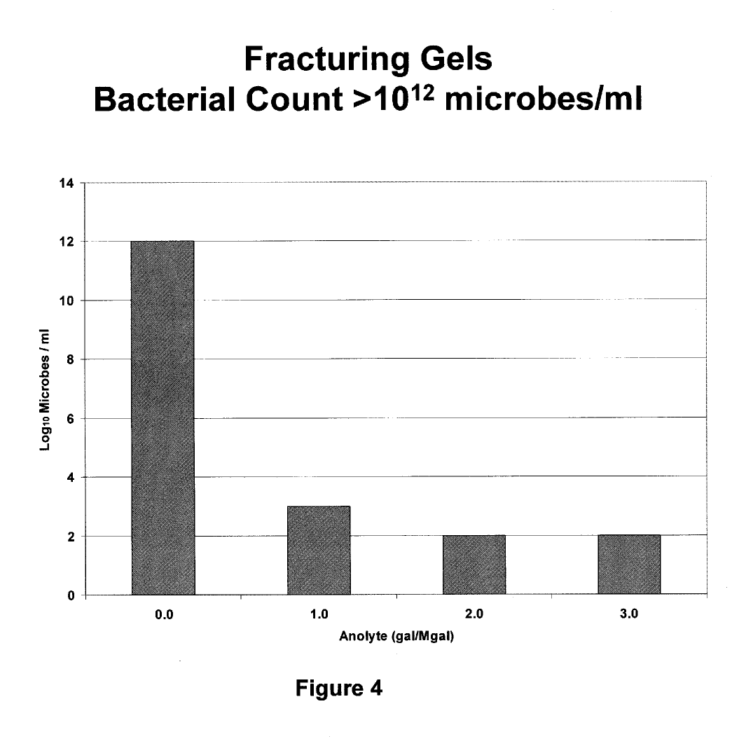

FIG. 5 is a table providing the results of time quench studies at pH 7.

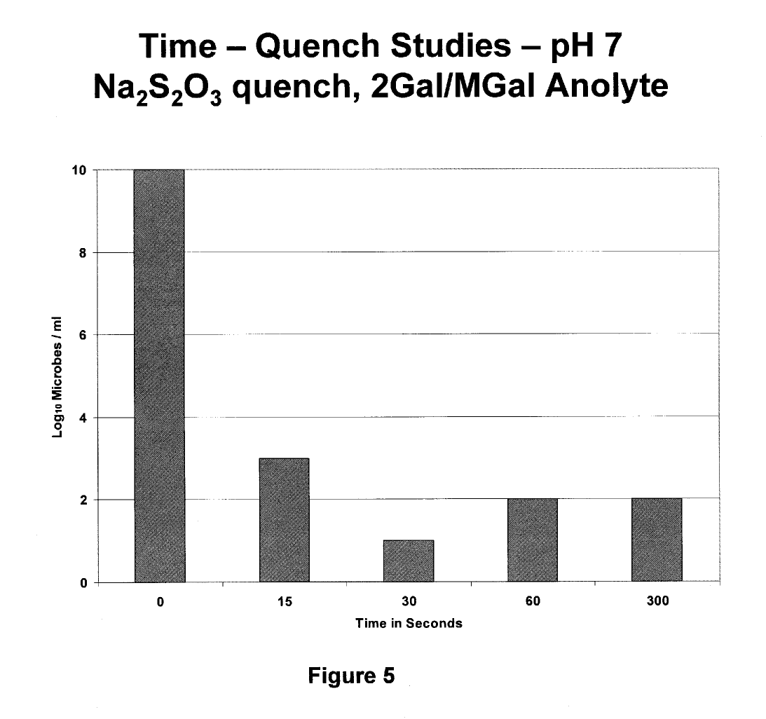

FIG. 6 is a table providing the results of time quench studies at pH 9.

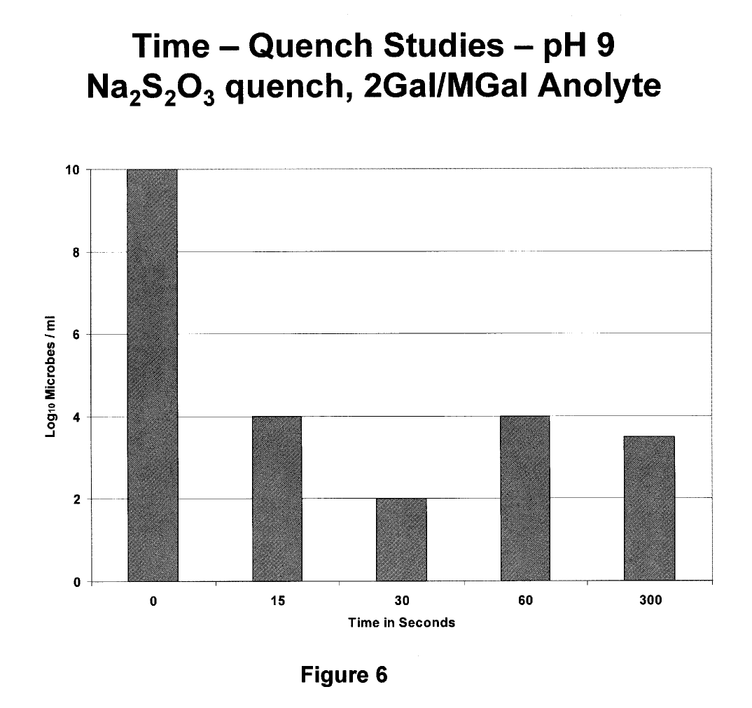

FIG. 7 is a graph of comparative solution concentration and time required for 99% destruction of E. coli using anolyte and hypochlorite.

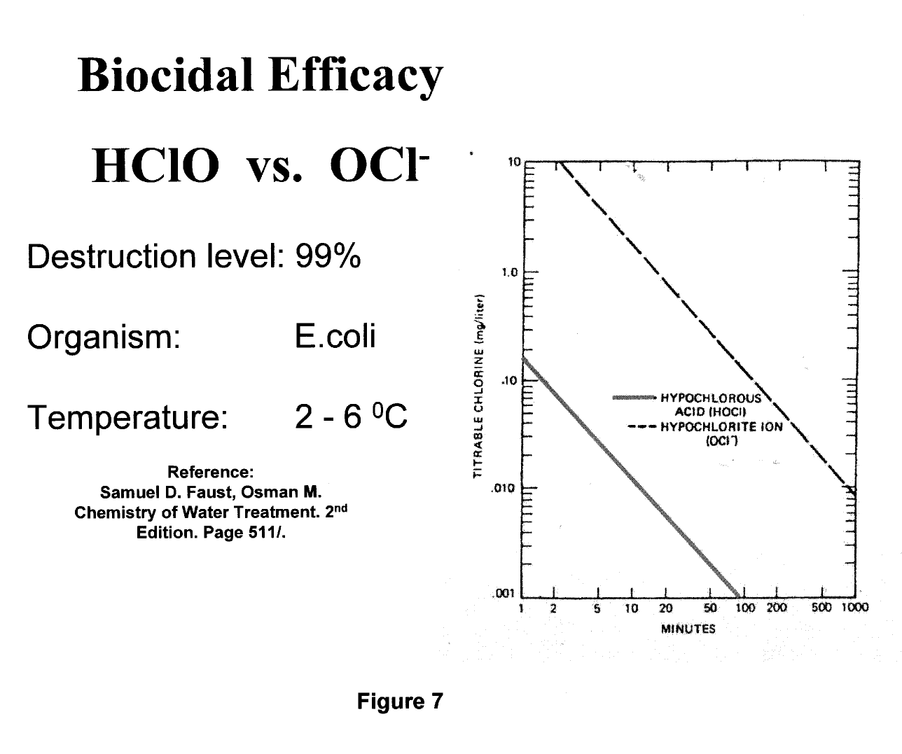

FIG. 8 is a flowchart which depicts the programming sequences required for operation of the electro-chemical conversion system.

FIG. 9 is a photograph illustrating the electrical circuitry used in operating the electro-chemical conversion system.

FIG. 10 is a photograph illustrating the mechanical layout of components used in operating the electro-chemical conversion system.

FIG. 11 is a diagram illustrative of a hydraulic flowpath useful in operating the electro-chemical conversion system.

### DETAILED DESCRIPTION OF THE INVENTION

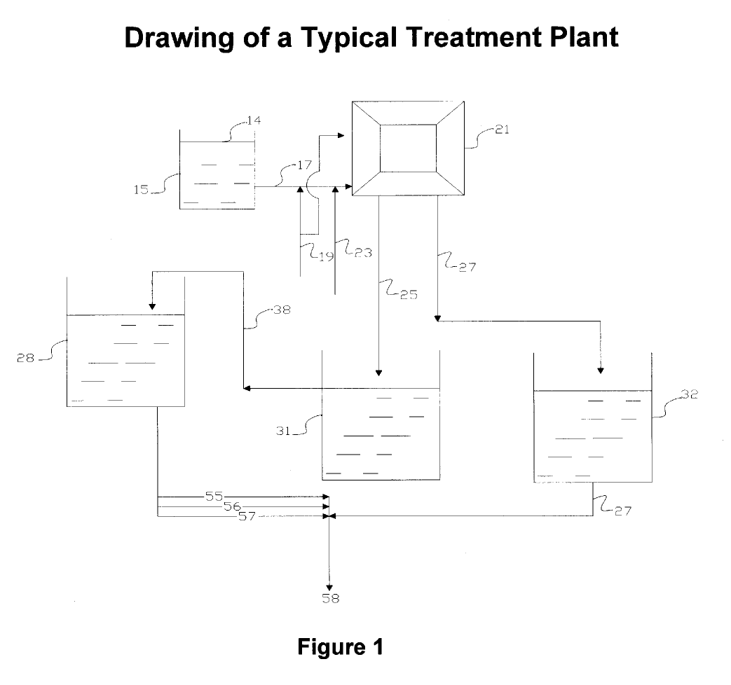

Preferred embodiments of the invention will now be described by way of an example, with reference to the accompanying schematic drawing illustrating a treatment plant in accordance with the invention, and by way of tests with reference to the tables. With reference to the FIG. 1, water containing <120 mg/l calcium carbonate and <30 micron particulate, is provided as shown at (14) in a water reservoir (15). If the process and the plant are to be operated with water inferior to the quality standards stated above, a pre-treatment step may be executed in the water reservoir (15), or in a container upstream of the water reservoir (15) to raise the quality of the water to that of acceptable quality water. A mother line (17) conducts water from the water reservoir (15) to wherever minimum standard quality water is required in the process as will become apparent hereinafter. Reference numeral (21) indicates an electrochemical reactor or so-called electrolysis device. Water from the motherline (17) is exposed to sodium chloride as indicated at (19) to produce a sodium chloride solution. The sodium chloride solution is fed into the electrolysis device (21), as well as water from the water reservoir as indicated by reference numeral (23). By electrolysis, an anion-containing solution or anolyte solution is produced as indicated by reference numeral (25). Also a cation-containing solution or catholyte solution is produced as indicated by reference numeral (27) and is collected in the catholyte tank (32). The anolyte solution at (25) is collected in the anolyte tank (31) as an anolyte solution of predetermined strength and pH, which can selectively be directed into an anion holding/transport tank (28). Water to be treated for microbes in accordance with the invention, for example water to be used in the preparation of fracturing fluids, is mixed with anolyte in a fracturing water container (55), or “on-the-fly” as indicated by reference numeral (56). Anolyte is drawn from the anolyte tank (31) as indicated at (38) and mixed with the fracturing water at a predetermined quantity and strength, to treat the water for microbes. After treatment, the water may be used for other admix applications with polymer gels (57) in containers or blending tanks before being directed into the well bore (58) to complete the fracturing process.

In accordance with the present invention, it is desirable, in the treatment of oil and gas well treatment operations, to provide a biocidal stream having a high ppm FAC (free available chlorine).

In prior art techniques, when employing a Constant Voltage Power Supply, increasing the Dilute Brine Concentration to produce strong ppm FAC solutions will increase the Current to the electrochemical reactor. Care must be taken since every electrochemical reactor has a current limit which if exceeded will exponentially reduce its life thereby causing pre-mature failure. While current limiting devices may be designed into the system to protect the equipment, power supply and/or electrochemical reactor, such devices would then not allow for strong brine solutions to be used to create strong ppm FAC solutions.

In accordance with the present invention, a unique (ECA) Electro-Chemically Activated solution platform is provided which utilizes a Constant Current Power Supply for the electrochemical reactor. This Constant Current Power Supply allows the user to select the desired DC Current within the designed current parameter range appropriate for the electrochemical reactor. The voltage of the Constant Current Power Supply will vary as needed in order to supply the desired Current across the electrochemical reactor at various Dilute Brine Concentrations. The voltage has no impact on the ppm FAC of the solution. Using Ohm's Law, V=IR or V=I/C, the following relations are realized. Increasing Current and holding the Dilute Brine Concentration constant will increase the voltage and increase the ppm FAC. Increasing Dilute Brine Concentration and holding the Current constant will also increase ppm FAC, but will reduce voltage. Increasing Current and Dilute Brine Concentration will compound the increase of ppm FAC, but affect the voltage with little or no change.

The converse of the above relations also exists. Consequently, for applications such as Oil and Gas Well Treatment Operations which require high ppm FAC solutions values, the Dilute Brine Concentration may be significantly increased, the Current value set at the maximum limit designed value and the electrochemical reactor will not be damaged by excessive current because the Constant Current Power Supply will limit the supplied Current and will compensate for the higher Conductivity by lowering the supplied voltage.

Employing the use of a pressure regulator in front of a flow meter with a manual dial to adjust the actual flow rate delivered at the set water pressure, the user has the ability to “Dial in” the flow rate. Using saturated brine for a known concentration starting point and then using a selectable speed-controlled peristaltic pump to deliver the desired volume of saturated brine, the user has the ability to “Dial in” the Dilute Brine Concentration.

With the user's ability to independently adjust and set all three strength (ppm FAC)-influencing factors (DC Current, Flow Rate and Dilute Brine Concentration) as constant values allows the instant ECA equipment to deliver solutions of desired parameters in an extremely user-flexible, yet consistent, reliable and repeatable manner.

In an alternative embodiment, measuring the strength of the Anolyte solution is accomplished using the Oxidation-Reduction Potential (ORP). ORP changes as a function of pH such that as pH decreases, ORP increases, and vice-versa. The pH is controlled through the use of a manual needle valve or, for more precise control utilizing a pH controller and PID Feedback control, the use of proportionally-controlled solenoid valves, proportionally-controlled stepping motor valves, and/or precision pumps to control the Catholyte flow such that a portion of Catholyte is either forced back through the anode chamber of the reactor or allowed to pass out through the Catholyte outlet. Although the ORP is mostly affected by the pH of the solution, it can still be fine-tuned with a Constant Current Power Supply which allows for varying voltages instead of a fixed voltage. Increasing the voltage potential (by decreasing conductivity, increasing current and/or increasing water flow) increases ORP.

### Tests:

An electro chemical reactor, including a flow-through electro chemical cell having coaxial cylindrical electrodes with a coaxial diaphragm between them so as to separate an annular inter electrode space into a catalytic and an analytic chamber, was used to produce anolyte and catholyte for the tests.

### Tests to 1-4

In a series of 4 tests, the compatibility and bactericidal effect of the anolyte solution was tested on waters typical of that which is used in the production of oil and gas. The experimental protocol and the subsequent results are summarized below in which the tests are numbered from 1 to 4.

### Test Procedures and Treatment

During Test 1, ampoules of pond water containing >12 log microbes/ml was treated with anolyte at loading rates of 0.25 to 2.0 gallons of anolyte per 1000 gallons of pond water with a five (5) minute contact time.

During Test 2, ampoules of the same pond water were treated at 1, 2 and 3 gallons per thousand gallons, left overnight and evaluated the following day for compatibility with fracturing gels.

During Test 3, quench tests using Na₂S₂O₃ were conducted on the same pond water to determine efficacy versus time using a loading rate of 2 gallons per thousand gallons.

During Test 4, guar-based culture tests were performed at culture dilution rates of 1/20 and 1/50.

### Microbiological Evaluation

Treatment test data from the above test protocols show a 9 log microbes/ml reduction in water treated with 1 gallon per thousand gallons for 5 minutes and with 2 gallons per thousand for 0.5 minutes. The Applicant believes that the oxidizing free radicals present in the anolyte solution act synergistically at a bacterial cellular level. It has been found that the effectiveness of the anolyte solution depends upon the flow rate through the reactor which determines the concentration of the anolyte, as measured in ppm free available chlorine (FAC), and by the oxidation-reduction potential (ORP), or redox potential of the anolyte solutions; the flow rate through the reactor and the exposure, or contact time between the microbes in the water being treated and the anolyte solution applied. A flow rate of 2.6 gallons/hour through an electro chemical cell has been found to be most effective. For example, by measuring the ppm FAC and redox potential of the anolyte solution during the treatment of water to be used for fracturing, the available free radical concentration can be determined and monitored. Anolyte has been found to be more effective at lower, rather than at higher, temperatures and at neutral pH ranges. It will be appreciated that many variations in detail are possible without departing from the scope and/or spirit of the invention as claimed in the claims hereinafter.

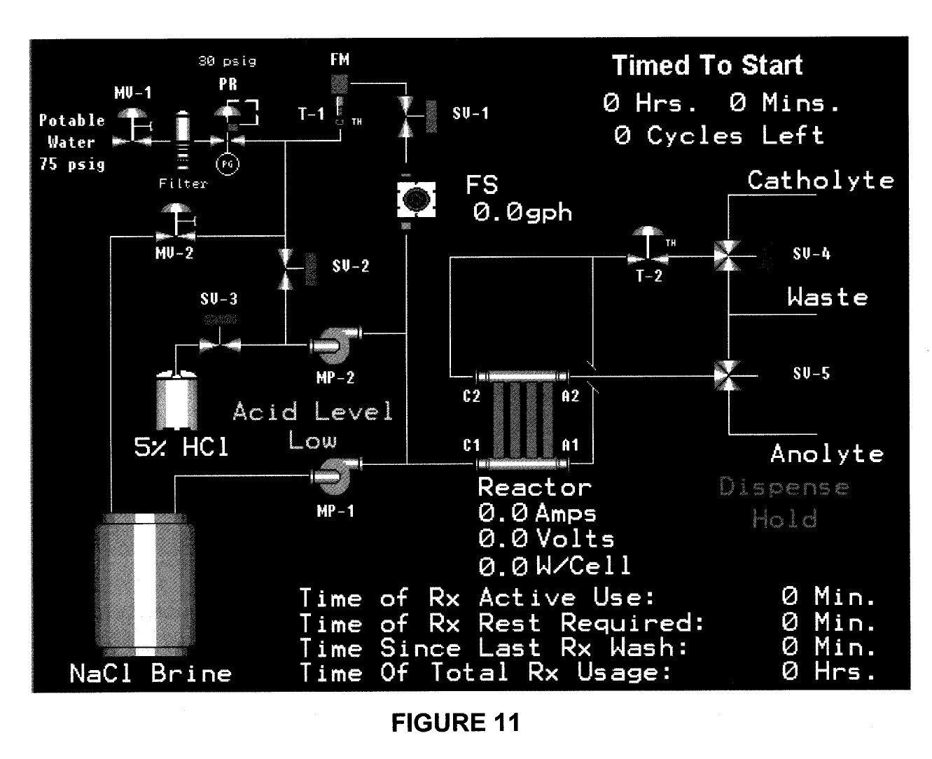

As will be further illustrated, the unique combination of software, electrical and mechanical systems act in concert, as illustrated in FIG. 11, to provide a hydraulic flowpath within which an electro-chemically based process functions to convert a weak brine solution into two solutions designated as anolyte and catholyte.

The equipment for producing the anolyte and catholyte solutions of the present invention includes a Programmable Logic Controller (PLC), Human Machine Interface (HMI), analog-digital (A-D) and digital-analog (DA) modules, utilizing factory programmed settings, user-defined input settings, and various feedback/PID systems, sensors, relays, switches and other electronic and/or mechanical devices to generate anolyte and catholyte solutions such that those solutions exhibit desired properties and characteristics in a predictable, repeatable, and consistent manner.

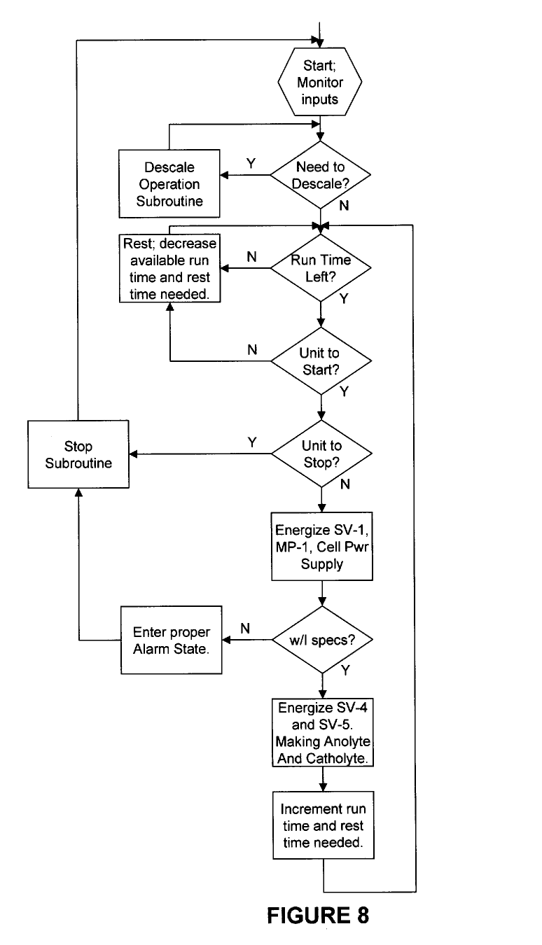

Now, with reference to FIG. 8, the basic programming flowchart, hereafter referenced as the “Catholyte-Anolyte Electrolytic Conversion Protocol” starts when the unit is powered on, self-monitoring various sensors, not yet operating, but awaiting user intervention before it starts its operational function. The user start intervention may be initiated by any of the following: actual on-site manual start, remote manual start, user-programmed delay start, automatic cycle restart or low level sensor mechanical switch start.

Upon receiving a start signal, the device undergoes a series of decision making logic before actually generating solution. If the device meets a preset user-defined operating time interval descale operation condition, then it will complete an automatic descale operation before continuing. The user may also elect to perform a manual descale operation at anytime. If the device has available active run time, then it will continue through the logic process.

Otherwise, it will rest and decrease (countdown) the active run time and rest time required conditions until they zero out or another start signal is received. If the unit still has an active start signal, it will continue through the logic process, otherwise it will go into the rest subroutine. If the unit does not have a stop condition, it will continue to start operating. If it does have a stop condition, it will go into the stop subroutine, which includes de-energizing certain solenoid valves, the electrolytic cell power supply(ies) and brine pump, while keeping the inlet solenoid valve (SV-1) energized for a preset time period to allow the water source to flush out the machine. The stop condition may be initiated by any of the following non-inclusive conditions: manual stop, end of user-defined run cycle time interval, high level sensor mechanical switch stop, or any alarm condition.

After completing a series of decision making logic to ensure the device meets all the conditions to start operation, it will start the operation sequence. The device, through the PLC, HMI, and various electronic, electrical, and electromechanical components will energize the inlet solenoid valve (SV-1) to allow water flow, the brine pump (MP-1) to inject the desired amount of brine into the source water stream, and the DC Constant Current Power Supply will be energized to deliver the desired user-defined current setting to the electrolytic cell(s). The device will continue to always monitor for various operational parameters. At a predetermined time interval, the device will begin to continuously apply decision making logic to various operational parameters. If any operational parameter is out of specification, it will go into the appropriate alarm state, stop routine and await further intervention. If all operational parameters are within specifications, the device will energize the catholyte and anolyte solenoid actuated three way valves (SV-4 and SV-5, respectively) to deliver the anolyte and catholyte product streams from the waste discharge into the appropriate anolyte and catholyte storage tanks or distribution manifolds. The device will then increment the active run time and rest time required conditions and continue to monitor for user or mechanical intervention and alarm conditions, ensure operational parameters are within specifications, record operational parameters onto memory storage media at predetermined time intervals and generate anolyte and catholyte product streams.

The device allows the user to input many user-defined programming settings including, but not limited to the following: electrolytic cell(s) (reactor) DC current, brine pump speed, run time interval, accumulative run time interval for automatic descale operations, delay start time in hours and minutes, number of successive cycles to complete before stopping, minimum flow rate alarm condition, flow rate scaling for sensor, and minimum reactor DC current alarm condition.

The device allows the user to employ high and low level limit switches/sensors or a float switch for automatic operation when filling tank(s). The device allows the user to remotely monitor, change user-defined programming settings and operate the equipment utilizing many different communications protocols including, but not limited to Ethernet IP addressing, modems, and SCADA.

The device monitors for various alarm conditions including, but not limited to low water flow, low DC current, high watts and descale solution low tank level.

The device allows the user to utilize one or more various methods of alarm reporting and/or relay signal output including, but not limited to flashing strobe lights, audible signals, automated dialer systems, electronic mail, text messaging and phone calls.

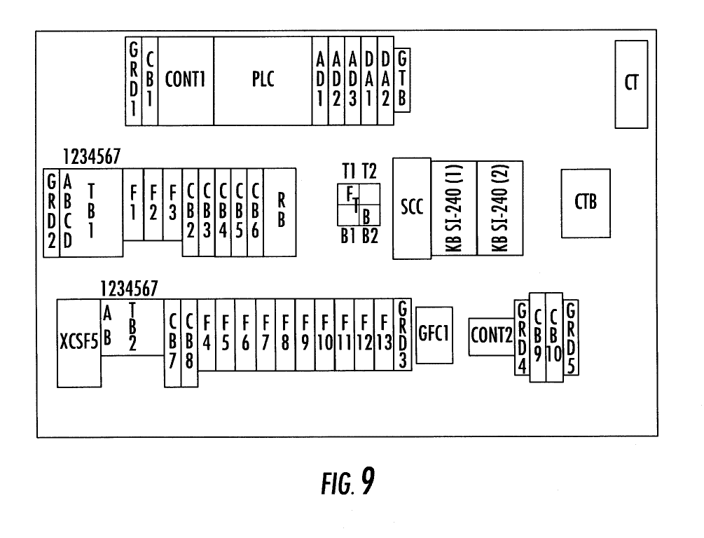

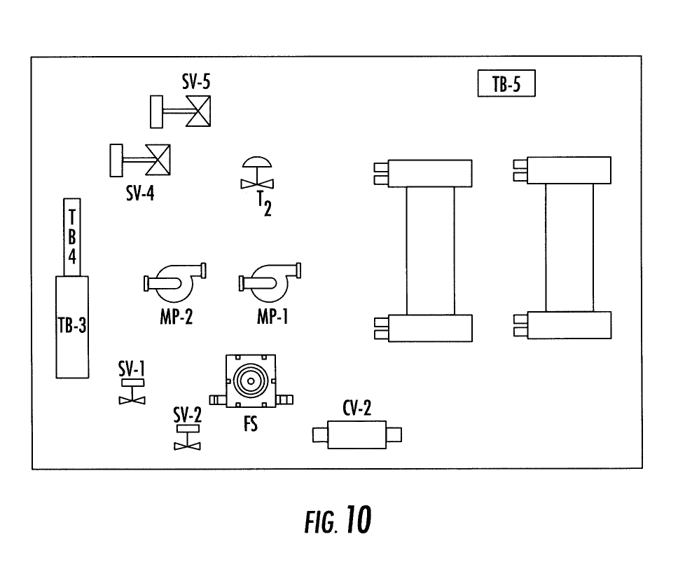

Referring to FIGS. 9 and 10, during normal operation, source water flows when the inlet solenoid valve (SV-1) is energized open allowing the water to flow through the flow switch/sensor (FS) and enter the Reactors at C1. Portioning pump (MP-1) is energized through a pump speed card according to the desired user setting which is the percentage of voltage from 0-24VDC. The higher the percentage, the higher the volts on MP-1 translating into a higher pump RPM and therefore injecting more saturated brine into the source water stream. The inverse holds true for a lower percentage of volts on MP-1. The FS sends a signal to the PLC (Programmable Logic Controller) to provide feedback on the actual flow rate. DC current at the desired user setting is delivered from an AC to DC Power Supply or Inverter to the positive and negative terminals (Anode and Cathode, respectively) of the electrolytic cell(s). The power supply will automatically adjust the voltage level output in order to achieve the desired DC current output. Subtle changes in water pressure, flow rate, salt saturation, water temperature, etc. may all cause the voltage to automatically adjust to ensure the desired DC current output is delivered. The current through the cell(s) and the voltage across the cell(s) are monitored by current sensing cards or CT(s) and voltage sensing card(s) or PT(s) and provide real-time sensor feedback to the PLC for automated monitoring and controlling operations. After a predetermined initial start time to allow the equipment to reach operating specifications, the catholyte and anolyte solenoid actuated three way valves (SV-4 and SV-5, respectively) are energized to deliver the anolyte and catholyte product streams from the waste discharge into the appropriate anolyte and catholyte storage tanks or distribution manifolds.

The FS, speed card, solenoid valves, portioning pumps, CT, relays, touch screen human machine interface (HMI) analog-digital (A-D) and digital-analog (DA) modules and most other electronics are typically operated using 24VDC power supplied from a 120/240 VAC to 24 VDC Power Supply.

The PLC, contactors, voltage sensing cards, 24 VDC power supply(ies), GFCI receptacles, brine tank circulating pump(s), fans, electrolytic cell(s) DC Constant Current power supply(ies) and water quality monitoring systems consisting of probes, controllers and PID Feedback control systems are typically operated using 120 and/or 240 VAC single phase power, but may sometimes utilize power delivered from various three phase AC voltage configurations.

With particularly reference to the hydraulic flow illustration of FIG. 11, it is depicted that during normal operation, source water flows through a manual isolation valve (MV-1), filter (F), and pressure regulator (PR) which is adjusted to reduce water pressure to about 30-35 psig. A throttle valve (T-1), installed at the inlet of the flow meter (FM), may be adjusted to allow a consistent, desired flow through the unit. Inlet solenoid valve (SV-1), when energized open, allows the water to flow through the flow switch/sensor (FS) and enter the Reactors at C1. A portioning pump (MP-1) may be energized and run at a slow speed to inject an appropriate amount of saturated brine from the brine tank into the water stream. The dilute brine solution, of reliably consistent concentration, enters the inlet to the Reactor (C1), at a rate that ensures proper operation of the Cells. As the dilute brine solution flows through the Cell Reactor, a conductive path for electric current is created and allows current to flow from the anode to the cathode of the Cells causing an electro-chemical conversion of the weak brine into anolyte and catholyte solutions.

After passing from C1 upward through C2, the catholyte (0-50%, but typically about 15-20% of total flow) exits the Reactor cathode chamber and flows through throttle valve (T-2), or another portioning/restrictive device, and through the energized open side of solenoid actuated three way valve (SV-4) into a storage tank or distribution manifold. The remaining catholyte (50-100%, but typically about 80-85% of the total flow) is directed into the anode chamber at A1 where it undergoes electrochemical conversion to anolyte and exits the Reactor at A2. Anolyte then flows through the energized open side of solenoid actuated three way valve (SV-5) into an anolyte storage tank or distribution manifold.

Under normal conditions the pH of the anolyte solution is adjusted to be about 6.5 to 7.5 to ensure the high efficacy of the anolyte solutions. To achieve this, throttle valve T-2, or another portioning/restrictive device, is initially throttled to force about 80-90% of the total flow exiting the Reactor cathode chamber from C2 into the anode chamber at A1. About 10-20% of the total flow then exits as catholyte solution via SV-4. T-2, or other portioning/restrictive devices, may then be finely adjusted to achieve the desired pH of the anolyte solution.

To raise the pH of the anolyte, T-2, or other portioning/restrictive devices, should be more restricted. This reduces the catholyte outflow and allows more of the high pH catholyte to flow through the anode chamber therefore raising the pH of the more acidic anolyte.

To lower the pH of the anolyte, T-2, or other portioning/restrictive devices, should be less restricted which allows less of the high pH catholyte to flow through the anolyte chamber therefore lowering the pH of the anolyte.

During operation, flow is always directed in an upward direction through the Reactor to ensure gases that are created during the electrochemical conversion process inside the Cells are carried, in solution, from the reactor. This orientation helps to avoid the build up of potentially dangerous gases inside the Reactor.

Minerals are present in most of the water throughout the United States. The minerals cause scale to build on the surfaces of the Cells during their operation. As the scale builds, the electro chemical conversion is decreased and the solution strength is diminished. To minimize the impact of scale build-up on the operation of the Cells, they must be periodically de-scaled by introducing an acid solution to the Reactor. This is done by attaching a container of de-scaling solution to the suction tube of MP-2. The operator then selects “Wash Cycle” on the HMI menu and de-scaling is automatically controlled by intermittent operation of solenoid valve SV-3 or check valve CV2 and Portioning pump MP-2. Weak acid solutions generated during de-scaling operations are sent to waste through solenoid valves SV-4 and SV-5. Since anolyte is a natural de-scaling agent, most of the scale buildup develops within the catholyte stream. In order to ensure the catholyte outlet flow is not compromised, SV-4 (catholyte 3-way solenoid valve) will momentarily energize throughout the acid wash operation. The amount of acid that goes through the catholyte line is minimal and will not cause any adverse affects to the catholyte when it is being collected in a tank for use. Upon completion of the acid de-scaling operations, MP-2, the Cell, the waste stream and momentarily the catholyte line, are automatically rinsed by operation of solenoid valve SV-2 and MP-2.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. An electrolyzed water solution including anolyte from a salt containing water characterized as containing from about 250 to about 700 ppm free available chlorine (FAC) hypochlorous acid in aqueous solution at 850+mV oxidation reduction potential (ORP) and at a ph of about 5.5 to about 7.5, and catholyte containing cleaning and surfactant properties in aqueous solution at about −600 to about −900 mV ORP and at a pH of from about 10.5 to about 12.0 produced in accordance with the following method steps:
providing a Catholyte-Anolyte Electrolytic Conversion Protocol operative to maintain controlled operation of a series of elements which function as a Programmable Logic Controller (PLC), Human Machine Interface (HMI), analog-digital (A-D) and digital-analog (DA) modules, and feedback systems, sensors, relays, and switches in a manner effective to produce said anolyte and catholyte solutions such that those solutions maintain their desired properties and characteristics in a predictable, repeatable, and consistent manner; and
providing at least one electrolytic cell, fluidly coupled to a water source which is in turn in fluid contact with a source of saturated brine, and in electrical connection with a constant current power supply, wherein, in accordance with instructions received via the Catholyte-Anolyte Electrolytic Conversion Protocol, said constant current power supply will vary voltage level outputs in order to maintain constant current output during production of catholyte and anolyte;
whereby predictable, repeatable, and consistent production of said anolyte containing water characterized as containing from about 250 to about 700 ppm free available chlorine (FAC) hypochlorous acid in aqueous solution at 850+mV oxidation reduction potential (ORP) and at a ph of about 5.5 to about 7.5, and said catholyte containing cleaning and surfactant properties in aqueous solution at about −600 to about −900 mV ORP and at a pH of from about 10.5 to about 12.0 is achieved.

2. The electrolyzed water solution including anolyte and catholyte of claim 1, wherein said salt is selected from one or more of sodium chloride, potassium chloride, magnesium chloride, naturally occurring sea-water, salt water, brackish water, or mixtures thereof and is from about 0.3% to about 3% by weight of the total weight of solution to be electrolyzed.

3. The electrolyzed water solution including anolyte and catholyte of claim 1, wherein the electrolytic cell is of a cylindrical design having a volume dimension of from about 100 milliliters to about 1000 milliliters and a diameter of no more than about 6.0 centimeters.

4. The electrolyzed water solution including anolyte and catholyte of claim 1, wherein the device may contain one or more electrolytic cells acting in parallel hydraulically.

5. The device of claim 4 wherein each electrolytic cell within the device manufactures from about 25 liters to about 500 liters per hour of an electrolyzed water solution of anolyte from salt water containing from about 250 to about 700 ppm FAC hypochlorous acid in aqueous solution at 850+ mV ORP and at pH from about 5.5 to about 7.5 and 25 liters to about 500 liters per hour of an electrolyzed water solution of catholyte from salt water containing cleaning and surfactant properties in aqueous solution at about −600 to about −900 mV ORP and at pH from about 10.5 to about 12.0.

6. A method of treating a well for producing, or enhancing the production of, petroleum hydrocarbons with an electrolyzed water solution of anolyte from salt water containing from about 250 to about 700 ppm FAC hypochlorous acid in aqueous solution wherein said electrolyzed water solution is contacted with desired areas in said well by introducing an effective amount of the electrolyzed water solution for reducing the presence of unwanted microorganisms to an acceptable level.

7. The method of claim 6 wherein said salt is selected from one or more of sodium chloride, potassium chloride, magnesium chloride, naturally occurring sea-water, salt water, brackish water, or mixtures thereof and is from about 0.3% to about 3% by weight of the total weight of solution to be electrolyzed.

8. The method of claim 6, wherein said electrolyzed water solution of anolyte has a pH greater than about 5.5 but less than about 7.5.

9. The method of claim 8 wherein the electrolyzed water solution of anolyte comprises from about 0.1% to about 100% of the treatment fluid volume and where the remainder is selected from any other compatible liquid.

10. The method of claim 9 wherein the electrolyzed water solution of anolyte may be applied continuously, periodically or in batch treatments.

11. The method of claim 9 wherein the compatible liquid is selected from the group consisting of water, well water, pond water, irrigation water, river water, storm-water, sea-water, produced water, re-cycled water, process water, waste-water, synthetic brines, or mixtures thereof wherein the pH of the electrolyzed water solution of anolyte and the compatible liquid is greater than about 3 and less than about 11.

12. The method of claim 6 wherein:
the electrolyzed water solution of anolyte is added to a surface vessel, or other means of man-made or natural water containment, prior to the addition of water or other fluids and prior to their intended use in the treatment of a well such that an effective amount of the electrolyzed water solution is contacted with the desired areas in the containment facility that will reduce the presence of unwanted microorganisms to an acceptable level.

13. The method of claim 6 wherein:
the electrolyzed water solution of anolyte is added simultaneously with other treating fluids during the treatment of a well such that an effective amount of the electrolyzed water solution is contacted with the desired areas in the containment facility that will reduce the presence of unwanted microorganisms to an acceptable level.

14. The method of claim 6 wherein:
the electrolyzed water solution of anolyte is added after other treating fluids during the treatment of a well such that an effective amount of the electrolyzed water solution is contacted with the desired areas in the containment facility that will reduce the presence of unwanted microorganisms to an acceptable level.

15. The method of claim 6 wherein:
a. the electrolyzed water solution of anolyte is added to reduce sulfur and iron reducing bacteria to an acceptable level; or where
b. the electrolyzed water solution of anolyte is added to reduce biomass and biofilm in the well structure to an acceptable level; or where
c. the electrolyzed water solution of anolyte is added to treat produced water and flow-back water to an acceptable level of microorganisms; or where
d. the electrolyzed water solution of anolyte is added to treat injection water for water-floods to an acceptable level of microorganisms; or where
e. the electrolyzed water solution of anolyte is added to improve the quality of sour wells and reduce the “black water” produced down-hole by bacteria to an acceptable level.

16. The method of claim 6 wherein:
a. the electrolyzed water solution of anolyte is added to treat fracture water in fracture tanks, pits and other storage facilities; or where
b. the electrolyzed water solution of anolyte is added to treat cooling water; or where
c. the electrolyzed water solution of anolyte is added to protect fracturing gel, water shut-off gel and other gel systems; or where
d. the electrolyzed water solution of anolyte is added as a “shock” treatment to heater-treaters, oil-water separators, storage tanks or storage systems.

17. The method of claim 6 wherein:
a. the electrolyzed water solution of anolyte is added to mitigate planktonic microorganisms; or where
b. the electrolyzed water solution of anolyte is added to mitigate sessile microorganisms as bio-film or bio-mass.

18. A method of treating water used for producing, or enhancing the production of, petroleum hydrocarbons, with an electrolyzed water solution of catholyte from salt water which contains catholyte as a surfactant in aqueous solution in a sufficient amount so that an acceptable level of reduction in the surface tension of the water being treated is achieved.

19. The method of claim 18 wherein said catholyte is added in a sufficient amount so that an acceptable level of enhancement of drilling fluids and drilling muds is achieved.

20. The method of claim 18 wherein said catholyte is added in a sufficient amount so that an acceptable buffering of the pH of the treated water is achieved.

21. The method of claim 18 wherein said catholyte is added in a sufficient amount so that petroleum hydrocarbon geologic formations, including shale oil and tar sands are contacted and petroleum hydrocarbons are concommitantly released and separated from the geologic formations in which they exist.
